(19) United States
(12) Patent Application Publication
(10) Pub. No.: US 2018/0354230 A1
(43) Pub. Date: Dec. 13, 2018

(54) REMOVABLE FLOORING SYSTEM

(71) Applicant: Dur-A-Flex, Inc., East Hartford, CT (US)

(72) Inventors: Ming Zhao, East Longmeadow, MA (US); Kyle Sanford Smith, South Windsor, CT (US); Murty Venkata Bhamidipati, Simsbury, CT (US); Michael Joseph Schatz, Colchester, CT (US); David Royston Hughes, Fairfield, CT (US)

(21) Appl. No.: 16/006,776

(22) Filed: Jun. 12, 2018

Related U.S. Application Data
(60) Provisional application No. 62/519,128, filed on Jun. 13, 2017.

(51) Int. Cl. B32B 7/06; B32B 7/12; B32B 27/06; B32B 27/12; B32B 27/20; B32B 27/08; B32B 5/02; B32B 5/18; B32B 3/26; E04F 15/12

(52) U.S. Cl. CPC B32B 7/06; B32B 2419/04; B32B 27/065; B32B 27/12; B32B 27/20; B32B 27/08; B32B 5/028; B32B 5/024; B32B 5/022; B32B 5/18; B32B 3/266; E04F 15/12; B32B 2260/021; B32B 2260/02; B32B 2260/046; B32B 7/12

(57) ABSTRACT

A removable multi-layered flooring system comprising a 1) a foundation or primer layer applied to an underlying flooring surface, 2) a peelable support comprising a supporting material and a cross-linkable or curable polymer composition that penetrates the supporting layer to form a unified, cohesive support that can be peeled from the foundation/primer layer in its entirety, and 3) one or more upper polymer layers applied to the top of the peelable support. The multilayered system can be applied to the surface of a sub-flooring, e.g., concrete, and remains secured until such time as a new flooring is desired, at which time the peelable support and upper polymer layers are removed, e.g., by peeling them from the foundation layer.

A removable multi-layered flooring system applicable to a variety of surfaces is provided, the flooring system comprising 1) a foundation or primer layer applied to a surface, 2) a peelable support comprising a supporting layer made up of mesh, sheet, fabric, fiber or other similar material, and a cross-linkable or curable polymer composition that penetrates the supporting layer to form a unified, cohesive support that can be peeled from the foundation or primer layer in its entirety without leaving hard to remove remnants of support adhered to the foundation or primer, and 3) one or more upper polymer layers applied to the top of the peelable support. The multilayered system can be applied to the surface of a sub-flooring, e.g., concrete, and remains secured until such time as a new flooring is desired, at which time the peelable support and upper polymer layers are removed, e.g., by peeling them from the foundation layer.

### BACKGROUND

Many different materials can be applied to an underlying flooring substrate, or sub-flooring, to provide a finished floor. For example, ceramic tile, vinyl tile, various laminates, linoleum and a variety of polymer coatings have been applied to a sub-flooring, which in some cases is a previously used, finished floor. Many of these are expensive or hard to remove in the event that a new floor is desired, e.g., decor change, wear or other damage, a change in how the space is used, or the need for a different set of flooring properties, such as changes to a hospital floor, the conversion of a production area to an office space or vice versa, a recreational area to a dining area or vice versa, etc.

There are flooring systems that are said to be readily removed from an underlying floor or sub-floor, but many such systems tend to be readily damaged, easily worn, poorly affixed to the underlying flooring substrate, or difficult to remove completely. Further, some sub-floors are uneven, cracked or damaged and must be cleaned, leveled or patched before the flooring is applied.

U.S. Pat. No. 5,851,618 discloses a floor coating system, usable on a variety of floor surfaces, comprising a release coating applied to a floor surface with a durable coating applied on the release coating, wherein the release coating and durable coating can be peeled away together from the floor surface when desired; or alternatively, a barrier coating applied to a floor surface with a durable coating applied on the barrier coating, wherein the durable coating can be peeled away from the barrier surface when desired.

U.S. Publication 2011/0097954 discloses a peelable coating for a surface substrate, e.g., a floor surface, comprising a base layer that is releasably peelably applied atop the surface substrate; a reinforcement layer located atop the base layer; and a bond layer applied atop the reinforcement layer for bonding through the reinforcement layer to the base layer. The base layer comprises one or more polymer resin selected from natural latex, pre-vulcanized natural latex, and high solids styrene-butadiene latex; the reinforcement layer comprises a fiberglass mesh, a bio-degradable composition mesh, and the bond layer is pure acrylic, styrene acrylic, carboxylated styrene butadiene, or a polyurethane dispersion.

Use of peelable, preformed laminates, prepared from the base, reinforcement and bond layers found e.g., in U.S. Publication 2011/0097954, applied to a floor surface with an adhesive are known, for example, as in U.S. Publication 2016/0319136.

Other similar systems are known, but deficiencies in many of these systems remain, e.g., cost, durability, installation or removal difficulties, and the like. There remains a need for an improved floor coating, which is durable, yet easily applied and removed.

### SUMMARY OF THE INVENTION

The present invention provides an improved multilayer, removable flooring for application to a variety of underlying flooring substrates, comprising 1) a foundation layer, or primer layer, adhered to an underlying flooring substrate, 2) a peelable support applied to the foundation layer or optional primer layer, and 3) one or more upper polymer layers, e.g., polymeric coating layers, wherein the peelable support and upper polymer layers are together readily removed the foundation layer, when desired.

As is standard in US patent practice, unless otherwise specified, “a” or “an” means one or more than one.

The peelable support comprises at least a supporting material such as a mesh, fabric, fibers, etc., and a curable polymer composition that penetrates the supporting material, and when cured, binds the adhesive layer, when present, and supporting material into a single, cohesive layer that can be readily peeled from the foundation layer. Typically, the peelable support comprises an adhesive layer, which is applied to the foundation layer and binds the peelable support to the primer or underlying floor surface. The curable polymer composition bonds with such an adhesive layer so that the adhesive layer, supporting material and curable polymer together form a single unified layer, which may be considered a laminate, that can be removed from the foundation layer when desired. Thus, the adhesive layer is bound less strongly to the foundation or primer layer, than to the curable polymer composition.

A curable polymer composition in this invention comprises a polymer, prepolymer, resin, or collection of monomers that cure or crosslink by chemical reaction after applied as part of the flooring system. This is differentiated from other polymer compositions, such as dispersions or emulsions of polymers in the form of particles, oils or liquids in a carrier, e.g., an organic solvent or water, that are essentially dried without the formation of new chemical species. Often, as in the case of epoxy compositions, 1-pack polyurethanes, 2-pack polyurethanes, etc., a curable polymer composition comprises a resin or prepolymer and a curing agent, e.g., a polyol including polyphenols, polyamine, amino-alcohol etc. In other cases, the curable polymer composition comprises a polymer, prepolymer, resin, or collection of monomers that will react together upon initiation, e.g., by heat, light, the action of radical initiators, etc., for example, curable acrylate compositions. Hybrid systems are also known, including those that use more than one curable chemistry and those that combine curable components and non-reactive polymers, which can also be employed as curable polymer compositions.

Curable polymer compositions may be used in any other layers of the multi-layer flooring system of the invention, but a curable composition must be used in preparing the peelable support in order to provide the desired level of penetration of the support material, the bonding strength necessary for forming a strong, unified peelable support, and the physical properties needed for proper functioning of the instant flooring system.

The adhesive can be almost any adhesive that binds the peelable support to the primer or underlying floor surface, but not as strongly as the crosslinked or cured polymer composition is bound to the supporting material and adhesive.

Typically the crosslinkable or curable polymer composition comprises a curable resin such as an epoxy resin, acrylate, methacrylate, acrylamide, methacrylamide, polyaspartic material or a urethane or urea prepolymer and the like, and a curative, e.g., polyol, polyphenol, polyamine, amino-alcohol etc., or the curable resin is a self-crosslinking polymer initiated by heat, light, radical formers, etc. For example, one or two pack urethanes, epoxy resins, curable acrylates and the like.

The supporting material can be a mesh, screen, foam or layer comprising e.g., fiberglass or synthetic polymer; a mesh screen or layer of naturally occurring materials such as jute, hemp, cotton, wool, cellulose, leather etc.; natural fibers or synthetic fibers such as those comprising glass, fiberglass, polyester, acrylate, polyolefin, polyamide, polyurethane, styrene; a woven or nonwoven fabric, etc.

The upper layers are adhesive or coating layers known in the art and may include curing compositions or coatings that set essentially due to the removal of a carrier, such as the evaporation of an organic solvent or water, e.g., polyurethane or acrylate dispersions, latex or the like.

### DESCRIPTION OF THE INVENTION

The multi-layer flooring system of the invention is prepared by forming a peelable support over a foundation layer on an underlining flooring substrate, and then applying one or more upper polymer layers to the peelable substrate.

The foundation layer is one or more polymeric layers applied to the underlying flooring substrate. The foundation layer is often applied as part of the process of constructing the flooring system of the invention, but may be a pre-existing layer, such as a sealer or primer coat previously applied to the underlying flooring.

Formation of the peelable support comprises positioning the supporting material over the foundation layer or adhesive layer, applying the curable polymer composition so that the composition saturates the supporting material and contacts or penetrates any adhesive layer that may have been applied to hold the supporting material in place, and then curing the curable polymer composition. In most embodiments, the peelable support will comprise an adhesive applied over the foundation or primer layer prior to the positioning of the supporting material.

The upper polymer layers are applied to a fully cured or partially cured peelable support, typically to a fully cured peelable support. The upper polymer layers may comprise any flooring coating of the art, or coating system of the art, that has adequate adhesion to the peelable support and the physical properties desired.

Methods for applying foundation layers, adhesion layers, floor coating layers are known in the art and need not be further discussed here. Likewise, preparation, application and curing of the curable polymer composition of the peelable layer is accomplished using any applicable known method, and sizing and positioning the supporting material is well within the skill of anyone familiar with the art.

The flooring system of the invention can be applied over almost any underlying flooring substrate, or even finished floor, which has sufficient cohesive strength to remain intact when the durable coating is pulled up, including sealed, polished or raw concrete or other masonry or stone, wood, metal, painted metal, asphalt, ceramic, porcelain or vinyl tile, various laminates, composites, linoleum, various plastics, polymeric floor coatings, etc., and may find use where applied over substrates used in non-flooring applications including glass, fiberglass, etc.

Focusing on the peelable support, the support material may comprise a variety of forms, e.g., a mesh, a woven or non-woven fabric sheet or strips, an array of loose, i.e., non-interlinking fibers, a perforated or porous sheet, foam, etc., and may comprise a variety of synthetic or naturally occurring materials including, fiberglass, fiberglass blends, polymers such as polyolefins, polyamides, polyesters, polycarbonates, acrylates including methacrylates, acrylamides including methacrylamides, polyurethanes, styrenes, polyvinyl alcohol, polyvinyl chloride, polyacetals, and the like, including co-polymers and polymer blends, naturally occurring materials such as cellulose, jute, hemp, wool, leather, cellulose, linen, etc., or composite materials.

As just a few examples, the support layer may be a mesh made of fiberglass, a fiberglass blend, polyester, polyamide, polyolefin, rubber, etc., a fabric comprising a polyolefin, polyamide, polyester, acrylic, cotton, wool, leather, linen, etc., a foam comprising polyurethane, polystyrene, etc., a sheet, preferably perforated, comprising a polyolefin, polyester, polyurethane, a collection of fibers comprising glass, synthetic polymers, and the like.

A few specific examples include a fiberglass mesh, or fiberglass blend mesh or a mesh prepared from a thermoplastic polymer, or a fibrous sheet. The overall thickness of the peelable layer can range from 5 or 10 mil to 100 or 150 mil, e.g., from 5, 10, 15, 20 or 25 mil, to 50, 75, 100, 125 or 150 mil, or 5 to 25 mil, 25 to 50 mil, 50 to 75 or 100 mil, or 75 to 150 mil. The support material is sized accordingly.

The support material is penetrated and saturated evenly with a curable polymer composition, which also binds to an adhesive layer if used, and upon curing strongly binds the materials of the peelable support into a separable layer with an even and level upper surface. Polymers other than those cured by chemical reaction after application of the curable polymer layer may be used in the curable polymer composition, the majority of the polymeric elements of this composition are materials that react during cure.

A variety of curable polymer systems may be used in the peelable layer, for example, any curable floor coating systems, including epoxy, urethane, urea, acrylates (including methacrylate), polyaspartic, and the like, or combinations thereof, can be used, including available 1 K and 2 K epoxy and urethane/urea, latex (1 k or 2 K) systems, which may be dispersed, suspended, or dissolved in an organic solvent or water, or which may be a neat liquid, and any process for initiating curing may be employed UV curing, anionic curing, electronic beam curing, peroxide curing, LED curing, melamine cure, etc. may be used.

Certain embodiments make use of curable epoxy or urethane systems. One example of a common epoxy system comprises an epoxy resin a polymeric reaction product of bis-phenol A and epichlorohydrin, an amine or Novolac curing agent, and optionally a hardener such as a polyoxyalkylene amine, although many other usable systems are known many of which are commercially available. Polyurethane systems typically comprise an isocyanate terminated, polyol-based prepolymer and a polyol, polyamine or hydroxylamine curative. Prepolymers are often combined with the curative just before application, i.e., a 2 k system, but 1 k systems comprising a blocked prepolymer and/or a blocked curative are known, as are other 1 k systems that require initiation before curing takes place. Many curable epoxy and polyurethane systems useful in the invention may also contain plasticizers, catalysts or cure accelerators.

Curable acrylate compositions can also be used in the curable polymer compositions of the peelable support, such as acrylates or methacrylates comprising pendant hydroxy or epoxy groups, those cured by radical initiation of an unsaturated bond and the like.

Curable polymer compositions such as those described above may also be used in other parts of the inventive flooring system, e.g., the foundation layer below the peelable layer, or upper layers above the peelable layer, but as stated above, a curable polymer composition in the peelable support is required in the invention.

Many other well-known adhesive, coating, and other polymer materials can be used in various layers of the present flooring. In addition to any adhesive that may be used in the peelable support, adhesives may also be used in application of the foundation layer or layers, or as one of the upper layers, for example, one may use an adhesive layer between the peelable support and other upper layers. Any adhesive with the desired adhesive properties may be used, including a variety of pressure sensitive adhesives, latex adhesives, acrylic adhesives, epoxy adhesives, adhesives applied as liquids or those applied in non-liquid form. Also, one may find in the foundation layer or upper layers, curable polymer compositions useful in the peelable support, other curable polymer compositions, coating compositions not based on curable polymers such as polyurethane dispersions, such as colloidal systems in which the polyurethane particles are dispersed in a continuous aqueous medium, coatings based on other acrylic, styrene or butadiene or copolymer chemistries, latex, pre-vulcanized natural latex, styrene-butadiene latex, polyvinyl alcohol, silicone materials, fluorinated material, etc.

Examples of curable compositions useful in the multilayer flooring system, particularly in the upper layers, include the fast curing acrylate and methacrylate coating compositions found in U.S. Pat. No. 8,669,301 and U.S. Pat. No. 9,657,191; U.S. Publication 2015/0191622 comprising a reactive acrylic based polymer comprising pendant acrylate or methacrylate groups, reactive, typically polyfunctional, unsaturated monomers, thermal or UV activated radical initiator, and optionally a tertiary amine accelerator; or U.S. Publication 2017/0029653 comprising a reactive polymer, oligomer or prepolymer having pendant acrylate or methacrylate groups, low odor acrylate or methacrylate monomers, an acrylate or methacrylate crosslinker, an isocyanate crosslinker, an initiator, and optionally a reactive diluent and/or bead polymer.

Coatings typically used in non-flooring applications may also be used in the inventive flooring system, for example composition found in copending application Ser. No. 15/366,975, two pack polyurethane coating compositions comprising a polyol, such as one or more hydroxyl functionalized acrylate or methacrylate resins, an isocyanate crosslinker, and polymeric microfibers.

Naturally a number of additives common in the art may be found in the layers and polymer compositions of the invention such as stabilizers, processing aids, rheology modifiers, colorants, fillers/reinforcing agents, and the like, for example: antioxidants, UV absorbers, HALS, catalysts, curing accelerators, curing inhibitors, hardeners, anti-static agents, flame retardants, plasticizers, dyes and pigments including effect pigments, metal flakes, opacifiers, optical brighteners, etc., thickeners, surfactants, dispersants, solvents, reactive diluents, wetting agents, detergents, tackifiers, nucleating agents, fatty acid salts, defoamers, air releasing agents, flow aids, leveling agents, matting agents, adhesion promoters, anti-slip agents, biocides, biocide, polymer chips and granules, fibers, minifibers, microspheres, cement, sand, quartz (colored or non-colored), silica, alumina, clay, talc, metal salts CaCO3, CaSO4, BaSO4, etc., glass fibers or beads, stone chips, aggregates, lime, ceramic, rubber granules, waxes, etc.

Of course, certain additives are more likely to be used in particular layers. For example, UV absorbers are of most benefit in upper layers as are anti-slip materials, waxes and certain decorative elements, e.g., colorants selected for a particular decor, colored chips etc. Certain dyes or pigments, not essential for providing the color of the flooring may be used in underlying layers as visual guides that are useful in the application of the various layers of the flooring system.

Further, it is well known that some additives have multiple uses and may be found in different layers for different reasons and at different load levels. For example, titanium dioxide is a filler, opacifier, colorant, can have use as a UV stabilizer, etc.

Installing the flooring system of the invention typically comprises:
providing a foundation layer on the underlying flooring surface, either by applying one or more polymer compositions or by assuring that an existing foundation layer is adequate;
applying adhesive layer(s) of the peelable support, positioning the support material on the adhesive and applying a curable polymer composition to evenly saturate the support material and provide a level surface at the upper part of the peelable support when cured;
applying one or more upper layers on the peelable support.

It is possible to apply the curable polymer composition before positioning the support material, but this may create complications, especially when installing the flooring system over a large area, as this composition cannot be cured until the support material is in place.

In many instances, the various polymer compositions applied in installing the inventive removable coating will be allowed to dry or cure before the next material or polymer composition is applied. In some cases however, it may be advantageous to apply the next material to a polymer composition that is not fully dried or cured. For example, greater adhesion of one polymer layer to another may be obtained by applying a subsequent polymer layer to one that is uncured or only partially cured.

One particular exemplary embodiment comprises the flooring obtained by applying a foundation or primer layer on a concrete floor and allowing the layer to cure or dry. Applying a layer of adhesive, e.g., a latex or hybrid blend of both pre-vulcanized natural rubber latex and styrene-butadiene-rubber copolymer latex, or other pressure sensitive adhesive. Laying a mesh of fiberglass, a fiberglass blend or a bio-degradable composition onto the adhesive layer. Applying an epoxy curing composition, or a curing composition comprising an isocyanate capped prepolymer and a curative in a manner that evenly saturates the mesh and contacts the adhesive layer and curing the curing composition. Applying one or more floor coating layers on the adhesive/mesh/cured polymer layer.

As one example, the mesh layer can be fiberglass or a fiberglass blend mesh having a weight of approximately 100-200 gsm, e.g., 145-160 gsm, and a square size of about 2-10 mm, e.g., 5-6.5 mm, but clearly other meshes are envisioned.

The adhesive layer may be in any stage of cure or drying when the mesh is laid, and when the curing composition is applied, e.g., the adhesive may be fully cured or dried, partially cured or dried, or fully cured or dried when the mash is applied, and when the curing composition is applied. In many embodiments the adhesive layer is fully cured or dried when the curing composition is applied.

There is no particular limit to the manner in which the coating layers or polymer compositions are applied, any known method compatible with the desired results may be employed. There is no particular limit to the thickness of each polymer layer, and one skilled in the art can readily determine the desired thickness based on what is known in the art about the chemistry and preferred application of these or similar layers. In general the approximate thickness of a foundation, adhesive or coating layer will range from 1 to 100 mils e.g., 1 to 50 mils, e.g., 1 or 2 to 5 or 10 mils. The number of such layers and the thickness will also be determined by the final thickness of the flooring.

When desired, the floor coating system of the present invention can be quickly removed by pulling the support layer and the upper coating layers, up in large sheets, leaving the original underlying floor surface and foundation layer, upon which a new support layer and upper coating layers can be applied.

The removable flooring systems of the present invention may be applied to a new flooring or sub-flooring surface. In some instances, a new subflooring substrate, such as concrete or other masonry will already be sealed with a layer that will serve as a suitable foundation layer, and the support layer may be applied directly thereto. However, there is no prohibition against applying an additional foundation layer over an existing foundation layer.

The removable flooring systems of the present invention can also be applied directly over a floor which has already seen use, over a floor which has an existing coating, a floor in poor condition, etc. The process of applying the layers of the present invention will provide the means for sealing, stabilizing, or repairing faults in the underlying flooring surface, and will also provide the means for leveling an uneven surface. It is generally not necessary to remove an existing coating on a flooring surface before applying the foundation layer, but it is preferable that loose debris and excessive dirt be removed. Certain floors may contain materials, such as a wax layer, or a loosely bound temporary layer that would interfere with strong bonding of the foundation layer and it is encouraged that such materials be removed prior to application of the flooring system of the invention.

One advantage of the present invention is that once a suitable foundation layer has been applied, the support and upper coating layers can be removed from the foundation layer and new support and upper coating layers can be applied directly onto the existing foundation layer if desired. Another advantage over the art is that there is no particular need for special preparations, such a taping the perimeter of area to be coated with a UV stable adhesive tape as in U.S. 2011/0097954. The use of a curable polymer composition in preparing the peelable support also allows for a stronger and more coherent peelable layer than found in the art.

The peelable floor coating system of the present invention as applied to a floor surface is easy to apply; is self-leveling; can use any kind of coating from very thin/low viscosity coating to the self-leveling, cove and to the troweling version, can be applied to many floor types; can be applied over floors in nearly any condition; can be easily peeled up by hand; can be easily reapplied to renew the floor surface; is readily modified to achieve any desired optical effects, e.g., color, gloss, etc., or performance characteristics such as a soft or hard floor, anti-slip floor, resistance to water, solvents, chipping etc., can readily provide a decorated floor containing decorative chips, quartz/stone and can be prepared using common methods and readily available materials. The floor can have one or more layers with different aesthetic and functional purposes, e.g., acoustic, elastic, antimicrobial, UV resistant, conductive, non-conductive, etc., which layers may have no thickness limitations.

1. A removable multi-layered flooring system comprising:
a foundation layer applied to a surface,
a peelable support comprising a support material and polymer composition that penetrates the supporting layer, wherein the polymer composition that penetrates the supporting material is formed from a curable polymer composition that is cured by chemical reaction after application to the support material; and
one or more upper polymer layers applied to the top of the peelable support.

2. The removable multi-layered flooring system according to claim 1, wherein the peelable support further comprises an adhesive layer that has been applied to the foundation layer.

3. The removable multi-layered flooring system according to claim 2, wherein the adhesive layer comprises a latex adhesive, acrylic adhesive, epoxy adhesive, polyurethane styrene, butadiene, or polyvinyl alcohol adhesive.

4. The removable multi-layered flooring system according to claim 3, wherein the adhesive layer comprises a latex, or a blend of pre-vulcanized natural rubber latex and styrene-butadiene-rubber copolymer latex.

5. The removable multi-layered flooring system according to claim 2, wherein the adhesive layer comprises a pressure sensitive adhesive.

6. The removable multi-layered flooring system according to claim 2, wherein the adhesive layer is UV curable, thermally cured or is a dispersion that is cured by drying.

7. The removable multi-layered flooring system according to claim 2, wherein the adhesive layer is a tape, sheet, or label.

8. The removable multi-layered flooring system according to claim 2, wherein the adhesive layer is applied as a liquid and cured during flooring installation.

9. The removable multi-layered flooring system according to claim 1, wherein the support material comprises a mesh, a woven or non woven fabric sheet, strips, non interlinking fibers, a perforated or porous sheet or foam, comprising one or more of fiberglass, fiberglass blends, polyolefins, polyamides, polyesters, polycarbonates, acrylates, methacrylates, acrylamides, methacrylamides, polyurethanes, styrenes, polyvinyl alcohol, polyvinyl chloride, polyacetals, co-polymers or polymer blends thereof, cellulose, jute, hemp, wool, leather, cellulose, linen or composite materials.

10. The removable multi-layered flooring system according to claim 9, wherein the support material comprises a mesh made of fiberglass, a fiberglass blend, polyester, polyamide, polyolefin or rubber; a fabric comprising a polyolefin, polyamide, polyester, acrylic, cotton, wool, leather or linen; a foam comprising polyurethane or polystyrene; or a perforated polymeric sheet.

11. The removable multi-layered flooring system according to claim 9 further comprising solid particles comprising sand, stone, quartz, clay, polymer chips, polymer granules, fibers, minifibers, microspheres, sand, quartz, silica, alumina, talc, CaCO3, CaSO4, beads, ceramic or rubber granules.

12. The removable multi-layered flooring system according to claim 1, wherein the curable polymer composition of the peelable support comprises a curable epoxy resin, acrylate, methacrylate, acylamide, methacylamide, polyaspartic material, urethane prepolymer, urea prepolymer, or hybrids thereof, and a polyol, polyphenol, polyamine, or amino-alcohol curative;
a blocked prepolymer and/or a blocked amine curative; a self crosslinking polymer, and optionally an initiator.

13. The removable multi-layered flooring system according to claim 5, wherein the curable polymer composition comprises an epoxy resin, a urethane prepolymer, a curable acrylate or a hybrid thereof.

14. The removable multi-layered flooring system according to claim 6, wherein the curable polymer composition comprises an epoxy resin or a urethane prepolymer and a polyol, polyphenol, polyamine, amino-alcohol, or blocked amine curative.

15. A process for installing the flooring system of any prcccding claim 1 comprising:
providing a foundation layer on the underlying flooring surface, either by applying one or polymer compositions or by assuring that an existing foundation layer is adequate;
applying an adhesive layer positioning the support material on the adhesive layer and applying a curable polymer composition to evenly saturate the support material and curing the curable polymer composition to provide a coherent peelable support comprising the adhesive layer, support material an cured polymer composition with a level surface; and
applying one or more upper layers on the peelable support, wherein each of the above layers can be of any desired thickness.
